(19) United States
(12) Patent Application Publication
(10) Pub. No.: US 2025/0061689 A1
(43) Pub. Date: Feb. 20, 2025

(54) SYSTEMS AND METHODS FOR LOGO DETECTION

(71) Applicant: Ad Lightning Inc., Seattle, WA (US)

(72) Inventor: Adam J. Robinson, Fairfax, VA (US)

(21) Appl. No.: 18/450,694

(22) Filed: Aug. 16, 2023

(51) Int. Cl. G06V 10/764; G06T 11/60; G06V 10/26; G06V 10/774; G06V 10/776; G06V 10/82

(52) U.S. Cl. CPC G06V 10/764; G06T 11/60; G06V 10/26; G06V 10/774; G06V 10/776; G06V 10/82; G06V 2201/09

(57) ABSTRACT

A logo detection system for detecting logos in digital images, such as online advertisements, is disclosed. In response to receiving an image containing a logo, the logo detection system generates synthetic advertisements by randomly transforming and placing the image of the logo into advertisement templates. The logo detection system uses these synthetic advertisements, along with advertisements that do not include the image, to generate a training set by applying an image encoder to the advertisements to extract feature vectors for each advertisement. The logo detection system constructs and trains a number of classification models by randomly assigning values to parameter values for the classification models. Each of these models is trained using the extracted feature vectors and the models are scored to find, from among the trained models, the model with the highest score. This model is retained for purposes of detecting the logo in images, such as online advertisements.

### TECHNICAL FIELD

The present technology relates to systems and methods for detecting logos in digital images.

### BACKGROUND

In many jurisdictions around the world, statutes and regulations require that user consent be obtained before tracking the user's online behavior. Current examples include the European Union's General Data Protection Regulation (GDPR) and California's Consumer Privacy Act (CCPA). To comply with such regulations, and to respect users' wish for privacy, website providers may prompt a user with a pop-up or banner notification asking for the user's consent to track the user's online behavior (e.g., through the use of cookies, beacons, etc.). When a user declines the use of cookies, for example, the website will not utilize cookies or other tracking techniques for that particular user or instance. Because the cost of noncompliance can be high (e.g., fees, penalties, reputational harm), website providers have strong incentives to ensure that user's choices with respect to privacy and tracking are respected so that, for example, users are not targeted with advertisements based on their browsing history if they have opted out (or not opted in) to tracking. Conversely, consumers and regulators may wish to identify when providers and trackers are noncompliant with these statutes and regulations by, for example, illegally re-targeting ads to consumers who have opted out (or not opted in), etc.

### BRIEF DESCRIPTION OF THE DRAWINGS

Many aspects of the present disclosure can be better understood with reference to the following drawings.

FIG. 1 is a block diagram illustrating an environment in which the logo detection system operates in accordance with some embodiments.

FIG. 2 is a flow diagram illustrating the processing of a generate logo detection model component in accordance with some embodiments.

FIG. 3 is a flow diagram illustrating the processing of a generate composite images component in accordance with some embodiments.

FIG. 4 is a block diagram illustrating example composite images in accordance with some embodiments.

FIG. 5 is a is a flow diagram illustrating the processing of a build candidate models component in accordance with some embodiments.

FIG. 6 is a flow diagram illustrating the processing of a detect logos component in accordance with some embodiments.

FIG. 7 is a flow diagram illustrating the processing of a score brand component in accordance with some embodiments.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

Many websites and other online resources track user behavior using cookies, beacons, or other techniques. This tracked user behavior can be used for a variety of purposes, such as personalizing web content, targeting advertising, and so on. Such tracking is regulated in many jurisdictions, for example requiring a user to opt-in or otherwise provide consent to the use of such tracking. In many cases, a website provider partners with a third-party consent management platform (CMP) that manages the content of user privacy notifications and user responses. Because noncompliance with privacy regulations can result in significant fines, penalties, or public backlash, website providers have an incentive to ensure that the user's choices regarding privacy and tracking are respected. It can be difficult, however, to confirm that a user who has opted out of tracking is in fact not being tracked while on the website. In some cases, for example, a particular website can have several or even dozens of trackers (e.g., DoubleClick, AdSense, Facebook Audiences, etc.). Accordingly, it is important to evaluate consent management related to online content such that any noncompliant trackers can be identified and removed from the target website or modified such that they no longer track users who have expressed a wish to not be tracked. Because these trackers can be used to target advertisements to users, identifying brands that are being advertised to a user can be helpful in determining whether a user is being tracked. For example, if a user visits the website of a particular car company or searches for a particular make or model of car and then sees an increase in the number of advisements from that car company or other car companies, the user may be concerned that they are being unlawfully tracked, especially if they have opted out of (or not opted into) one or more tracking mechanisms. However, some users may not be vigilant about monitoring which advertisements are being presented if they are consuming content, if the advertisements are unobtrusive, if they are focused on content, etc. Accordingly, without a method for automatically tracking which brands are being advertised to a user, the user may not find out that certain ads or types of ads are being targeted to the user.

One technique for automatically determining whether advertisements from a particular company or brand are being targeted to a user is to identify or detect logos for that company or brand in online advertisements presented to the user. Automated logo detection is a computer vision technology for identifying logos in digital images and can be used to, for example, identify advertisements associated with brands and their associated logos, add metadata to digital images, etc. Prior logo detection methods use large, slow, monolithic data structures and models that take a significant amount of time to update and re-train to detect new logos (i.e., logos that have not been introduced to the model). Accordingly, an improved machine learning based method for automatically detecting logos in digital images that can rapidly be updated to detect new or previously unseen logos is desired.

An improved logo detection system comprising methods and systems for detecting logos in digital images, such as online advertisements, is disclosed. The disclosed logo detection system trains and uses smaller, faster logo detection models than conventional logo detection systems rather than relying solely on large, monolithic data structures and machine learning models to detect logos in digital images. These smaller, faster logo detection models can leverage the feature extraction abilities of a pre-trained image encoder to generate training sets for the logo detection models. Thus, logo detection models for new or unseen logos can be trained without re-training the image encoder. Because the image encoder itself does not need to be re-trained for the logo detection system to detect new logos, the disclosed logo detection system is able to detect new or unseen logos using fewer storage and processing resources than conventional logo detection systems. Accordingly, the disclosed logo detection system offers significant advantages over conventional systems.

In some embodiments, the logo detection system initially receives one or more logo images (i.e., digital images that include the logo) and an indication of a brand name (e.g., Nike) associated with the logos. For example, some companies may have multiple logos or logo variations (e.g., SWOOSH, JUMPMAN, SWINGMAN, etc.) for different applications or placements, such as banner advertisements, email advertisements, overlay advertisements, and so on. In some cases, the logo detection system may apply one or more pre-processing techniques to each logo image to further isolate and/or normalize each logo within the logo image, such as removing or standardizing background colors (e.g., via a background-to-alpha technique), cropping a logo image to a smaller size without occluding the logo, removing compression artifacts from a logo image (e.g., via a flexible blind convolutional neural network), converting images to a standard file type (e.g., JPEG, TIFF, PNG, BMP), and so on. After the logo images have been processed, the logo detection system can store the logo images in association with the brand name.

After the logo images are received and/or stored, the logo detection system can construct, for each logo image, a set of synthetic advertisements that include the logo image. In some examples, this process is performed by randomly transforming a logo image (or a copy of the logo image) and inserting or compositing the transformed logo image into one or more advertisements or “advertisement templates.” These transformations can include any one or more of affine transformations (e.g., rotating, mirroring, scaling, stretching, skewing, etc.), filter transformations (e.g., smoothing, contrast reduction, etc.), color transformations (e.g., swapping color palettes or color palette entries, adding or removing colors, gray scale, black and white, etc.), and so on. Thus, multiple random transformations may be applied to a logo image before it is inserted into an advertisement template at, for example, a random position. In some cases, an advertisement template may include one or more markers for inserting a transformed logo rather than inserting the transformed logo at a random position.

The logo detection system can generate hundreds, thousands, or even more of these composite or “synthetic” advertisements (which are conceptually similar to what a real advertisement that includes the logo image would look like) for training purposes. In some cases, the same transformed logo may be composited or inserted into multiple advertisement templates. In this manner, the logo detection system provides a wide variety of machine learning training examples that include the logo but that will reduce the likelihood of overfitting on particular features of the logo image. In some cases, the advertisement templates that the transformed logo images are inserted or composited into can include advertisements scraped from online resources, custom advertisements provided by a user or administrator of the logo detection system, previously stored advertisements, and so on. Furthermore, these advertisement templates may be stored in an advertisement store for retrieval. In some cases, the logo detection system may periodically scrape the web for advertisements to use as advertisement templates and/or purge advertisements from the advertisement store so that the set of composite advertisements are generated based on recently encountered or updated advertisements.

In addition to the set of advertisement images that include a particular logo image, the logo detection system also retrieves or constructs advertisements that do not include the logo image (or a transformation thereof). In this manner, the logo detection system uses positive examples (e.g., advertisements that include the logo image or a transformed version of the logo image) and negative examples (e.g., advertisements that do not include the logo image or a transformed version of the logo image) as a training set to train logo detection models. These negative examples may comprise hundreds, thousands, or more advertisements scraped from the web, provided by a user or administrator, composited using other received logo images (i.e., logo images associated with a different brand), and so on.

In some examples, after the training set of positive and negative examples is constructed, the logo detection system applies a trained image encoder to advertisements in the training set to generate a feature vector for each advertisement. One of ordinary skill in the art will recognize that an image encoder may be generated using any number of feature extraction algorithms. For example, Learning Transferable Visual Models from Natural Language Supervision by Radford et. al (February 2021), which is hereby incorporated by reference in its entirety, describes an image encoder used to compute feature representations from images. Similarly, An Image Is Worth 16×16 Words: Transformers for Image Recognition at Scale by Dosovitskiy (January 2021) et al., which is hereby incorporated by reference in its entirety, describes using Natural Language Processing techniques to encode images. Other known feature extraction algorithms that can be used to train an image encoder can include the Scale-Invariant Feature Transform (SIFT) algorithm, the Speeded Up Robust Features (SURF) algorithm, the Features from Accelerated Segment Test (FAST) algorithm, the Binary Robust Independent Elementary Features (BRIEF) algorithm, and so on. As discussed above, because the disclosed logo detection system does not need to re-train the image decoder in order to detect new or unseen logos, the logo detection system conserves valuable storage and processing resources compared to conventional systems.

In some examples, the logo detection system feeds the advertisements in the training set through an image encoder comprising a neural network optimized to extract features from logos. One of ordinary skill in the art will recognize that an image encoder may be trained using various types of images and can be optimized for a particular type of image by curating positive examples for the training processing. The neural network may take an image as its input and produce a fixed length (e.g., 128 bytes, 256 bytes, 512 bytes, etc.), one-dimensional vector of real numbers as its output, the vector comprising information used to distinguish images from each other. In some cases, the neural network is trained to explicitly reduce cosine similarity between unrelated images and increase cosine similarity between related images (e.g., images that include the same or similar logos) so that: vectors produced from images containing the same logo have a high cosine similarity (e.g., above a predetermined threshold, such as 0, 0.5, etc.), vectors produced from images containing different logos have a low cosine similarity (e.g., below a predetermined threshold, such as 0.-0.5, etc.), vectors produced from images containing no logos having low cosine similarity with vectors produced from images containing logos, cosine similarity/dissimilarity being unaffected by the presence of features in the image unrelated to logos (e.g., text, vector graphics, uniform background colors, images of real objects), etc. Based on this training, the neural network can extract information pertaining to logos in an image without ever having seen the logo before. While this neural network image encoder may be large, it does not need to be re-trained to detect new logos, thereby reducing the amount of valuable processing and storage resources needed to detect new or unseen logos.

In addition to vectorizing each of the advertisements in the training set (i.e., generating feature vectors for the advertisements), the logo detection system builds or generates a set of classification models that can be trained to detect the logo using the generated encodings or feature vectors. In some embodiments, the logo detection system builds a set of classification models by randomly selecting a classification model type or architecture (e.g., naïve bayes, k-nearest neighbors, stochastic gradient descent, logistic regression, gaussian process, multi-layer perception, and so on), identifying a range of acceptable values for each of one or more parameters and/or one or more hyperparameters (e.g., k in a k-nearest neighbor algorithm, learning rate for training a neural network, train-test split ratio, batch size, number of epochs, branches in a decision tree, number of clusters in a clustering algorithm, regularization strength, choice of optimization algorithm, etc.) for the selected model architecture, randomly selecting a value in the range, and assigning the selected value to the parameter or hyperparameter. After the parameter values are determined, the logo detection system trains and stores the model for scoring. In some embodiments, the logo detection system may build tens, hundreds, thousands, or more classification models that can then be trained and scored to find the model that performs best for detecting the logo in images. For example, one of ordinary skill in the art will recognize that classification models may be scored based on training and validation scores, positive class validation accuracy, negative class validation accuracy, over-fit of the models, and so on, or any combination thereof. This model can then be stored in association with the brand and corresponding logo image and subsequently used in a process for detecting logos in advertisements (or other images) while the other models can be discarded. In some cases, multiple models may be selected if, for example, their scores are within a predetermined threshold (e.g., 1%, 5%, etc.) of the highest scoring model. Because these models can be small (e.g., under 10 KB) with minimal processing requirements (e.g., under 1 ms on a single core CPU), the logo detection system can provide logo detection models that require less storage and processing requirements than conventional logo detection systems.

In some cases, classification models may be any of a variety or combination of machine learning classifiers (e.g., classifiers optimized for the two-class classification problem) including neural networks such as fully-connected, convolutional, recurrent, autoencoder, or restricted Boltzmann machine, a support vector machine, a Bayesian classifier, and so on. When the classification model is a deep neural network, the training results in a set of weights for the activation functions of the deep neural network. A support vector machine operates by finding a hyper-surface in the space of possible inputs. The hyper-surface attempts to split the positive examples (e.g., feature vectors for images that include a particular logo) from the negative examples (e.g., feature vectors for advertisements that do not include the logo) by maximizing the distance between the nearest of the positive and negative examples to the hyper-surface. This step allows for correct classification of data that is similar to but not identical to the training data. Various techniques can be used to train a support vector machine.

Adaptive boosting is an iterative process that runs multiple tests on a collection of training data. Adaptive boosting transforms a weak learning algorithm (an algorithm that performs at a level only slightly better than chance) into a strong learning algorithm (an algorithm that displays a low error rate). The weak learning algorithm is run on different subsets of the training data. The algorithm concentrates more and more on those examples in which its predecessors tended to show mistakes. The algorithm corrects the errors made by earlier weak learners. The algorithm is adaptive because it adjusts to the error rates of its predecessors. Adaptive boosting combines rough and moderately inaccurate rules of thumb to create a high-performance algorithm. Adaptive boosting combines the results of each separately run test into a single, very accurate classifier. Adaptive boosting may use weak classifiers that are single-split trees with only two leaf nodes.

A neural network model has three major components: architecture, cost function, and search algorithm. The architecture defines the functional form relating the inputs to the outputs (in terms of network topology, unit connectivity, and activation functions). The search in weight space for a set of weights that minimizes the objective function is the training process. In one example, the classification system may use a radial basis function (“RBF”) network and a standard gradient descent as the search technique.

In some embodiments, the logo detection system builds and stores a logo detection model for a logo by constructing positive examples of advertisements that include the logo, generating feature vectors for those positive examples and for negative examples, randomly constructing classification models, training those models using the generated feature vectors, scoring the models, and then identifying the model(s) with the best or highest score(s). As disclosed in further detail below, this model (or models) can be applied to an advertisement (or other image) to determine whether the advertisement (or other image) includes the corresponding logo.

For example, the logo detection system may receive a request to determine whether an online advertisement includes logos associated with one or more identified brands. For each of the one or more brands, the logo detection system identifies logo detection models that have been created and stored for that brand, such as different logo detection models for different logos associated with the brand. The logo detection system applies the models to the online advertisement to compute a likelihood that the online advertisement includes the corresponding logo. In some cases, the logo detection system may split the online advertisement into a plurality of individual subsections, or “patches,” and apply the model to each of the patches to determine, for each patch, a likelihood that the patch includes the logo. In this case, the logo detection system may generate a score for the model based on, for example, an average likelihood of the patches whose score is above a predetermined threshold (e.g., 50%, 75%, etc.), a count of the number of patches having a likelihood above a predetermined threshold (e.g., 50%, 70%, etc.), and so on. If the score for the model exceeds a predetermined threshold, the logo detection system identifies the online advertisement as including the logo and, therefore, being an advertisement for the brand.

Based on these results, the logo detection system can provide a report indicating, for example, the likelihood that the advertisement includes a particular logo, a logo associated with a particular brand, and so on. By analyzing a stream or set of advertisements presented to a user, the logo detection system can identify the rate at which logos and brands are presented to different users and compare these rates to the general population and/or a set of simulated users to determine whether a user is receiving more ads than the general population. If so, the brand can be flagged for further investigation into whether the advertising is the result of unlawful re-targeting without the user's consent, a matter of there being a correlation between the user's online habits and the brand's marketing campaign, and so on.

In some examples, the logo detection system uses an expanded training set of images to train a number of smaller, faster logo detection models. This expanded training set of images is created by applying a number of transformations to a logo and randomly inserting the transformed logo into a number of advertisements or advertisement templates. The logo detection models are then trained with this expanded training set using one or more machine learning algorithms (e.g., stochastic learning with backpropagation). In some cases, introducing this expanded training set increases false positives when classifying images that do not include the logo. The number of these false positives can be reduced by performing an iterative training algorithm that retrains a model with an updated training set containing the false positives produced after logo detection has been performed on a set of images. This combination of features provides a logo detection model that can detect logos in distorted images while reducing the number of false positives. In some examples, the logo detection system comprises a computer-implemented method of training a neural network for logo detection comprising: receiving a digital logo image, collecting a set of digital images from a database, such as an advertisement store. In response to collecting the set of digital images, the logo detection system creates a modified set of digital images by, for each digital image in the set, applying one or more transformations to the digital logo image, such as randomly re-sizing, randomly re-coloring, randomly rotating, and so on, and inserting the transformed digital logo image into the digital image. The logo detection system creates a first training set comprising the collected set of digital images, the modified set of digital images, and a set of digital images that do not include the digital logo image and trains the neural network in a first pass using the first training set. Subsequently, the logo detection system creates a second training set for a second pass of training comprising the first training set and digital images that do not include the digital logo image that were incorrectly detected as including the digital logo image after the first pass of training and trains the neural network in a second pass using the second training set.

While some examples described herein may refer to functions performed by given actors such as “users,” and/or other entities, it should be understood that this is for purposes of explanation only. The claims should not be interpreted to require action by any such example actor unless explicitly required by the language of the claims themselves.

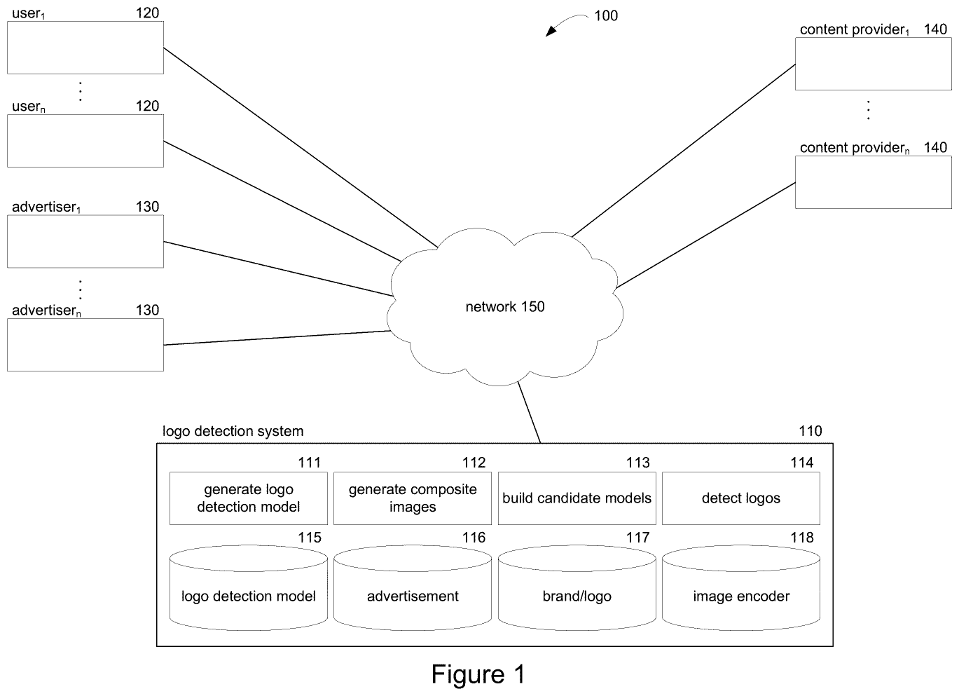

FIG. 1 is a block diagram illustrating an environment 100 in which the logo detection system operates in accordance with some embodiments of the disclosed technology. In this example, environment 100 is comprised of logo detection computing system 110, user computing systems 120, advertiser computing systems 130, content provider computing systems 140, and network 150. Logo detection computing system hosts generate logo detection model component 111, generate composite images component 112, build candidate models component 113, detect logos component 114, logo detection model store 115, advertisement store 116, brand/logo store 117, and image encoder store 118. Logo detection computing system 110 invokes generate logo detection model component 111 to generate and store a logo detection model for a logo image, such as a logo image for a logo associated with a brand, and may be invoked multiple times to generate logo detections for multiple logos associated with a brand. In some examples, the generate logo detection model may be invoked periodically (e.g., once per day, once per week, once per month) and/or on demand to generate a new logo detection model for one or more logo images. Generate composite images component 112 is invoked by the generate logo detection model to generate synthetic advertisement images that include the logo image for which the generate logo detection model component 111 was invoked. In some examples, generate composite images component 112 generates composite or synthetic images by randomly transforming a logo image and inserting the logo image into a randomly selected advertisement, such as an advertisement from advertisement store 116. Build candidate models component 113 is invoked by generate logo detection model component 111 to build random models for detecting a logo image, which are then trained and scored to select one or more models for detecting a particular logo in digital images. Detect logos component 114 is invoked by the logo detection system to detect one or more logos, such as logos associated with a brand, in one or more target images, such as an online advertisement, based on the generated logo detection models. In some examples, the detect logos component 114 is invoked in response to request from a user (e.g., a consumer, regulator, system administrator, etc.) that includes (or references) one or more target images and a brand name or logo images. In some examples, the detect logos component 114 invokes a score brand component (not shown) to assign, for example, scores to logos associated with the brand, each score corresponding to a probability that a target image includes the logo. Logo detection model store 115 stores logo detection models generated by generate logo detection model component 111. In some cases, the logo detection models stores, for each logo detection model, a model architecture associated with the logo detection model, an indication of an image encoder used to generate a training set for the logo detection model, a brand associated with the logo detection model, a logo image associated with the logo detection model, a number of model parameters or hyperparameters associated with the logo detection model and corresponding values, a date and time that the logo detection model was generated, metadata associated with the logo detection model, an indication of advertisements and transformations used to generate training date for the logo detection model, and so on. In some cases, logo detection model store may also store information about model architectures that can be trained for logo detection, such as code for training these models, parameters and/or hyperparameters associated with these models, acceptable ranges associated with these parameters and/or hyperparameters, and so on. Advertisement store 116 stores digital images corresponding to online advertisements, such as advertisements scraped from the web, advertisements provided or generated by one or more users, and so on, along with metadata about the advertisement, such as when or where the advertisement was encountered, brands associated with the advertisement, and so on. Advertisements stored in advertisement store 116 may be periodically purged depending on their age. Brand/logo store 117 stores associations between brands and logos and may include references to one or more logo detection models associated with a brand, references to image encoders uses to generate a training set for a corresponding logo detection model, references to logo images associated with a brand, and so on. Image encoder store 118 stores one or more image encoders used to extract feature values or feature vectors from image, such as a residual neural network (resnet) based image encoder, a visual transformer (ViT) encoder, and so on. Moreover, one of ordinary skill in the art will recognize that these image encoders can be optimized to extract features from logos by using training sets that specifically include logos. In some cases, the data stores 115-118 may share information or maintain links (e.g., foreign keys) between them. Users, such as consumers, regulators, system administrators, and so on, can interact with the logo detection computing system 110 via user computing systems 120 over network 150 using a user interface provided by, for example, an operating system, web browser, or other application. Users may interact with the logo detection system by sending a request the logo detection computing system to identify whether logos for one or more brands are included in one or more target images, such as a particular advertisement or a stream of advertisements (or other images) sent to the user while, for example, browsing the web, interacting with social media, and so on. Advertisers can interact with the logo detection computing system 110 via advertiser computing systems 130 over network 150 using a user interface provided by, for example, an operating system, web browser, or other application. Advertisers, such as companies, brands, third-party advertising platforms, etc. may interact with the logo detection system by sending new or updated logo images to the logo detection computing system 110. In response, the logo detection system can generate a new logo detection model for the new or updated logo images. In this manner, the logo detection system can remain up to date, thereby increasing the chances that unlawful targeting of the advertiser's brand will be caught earlier if, for example, a third-party advertising platform is not honoring preferences in tracking online behavior. Content provider computing systems 140 provide content for user consumption, such as websites, social media platforms, gaming platforms, and so on and may contract with advertisers to provide advertisements with content. Although shown as separate computing systems, one of ordinary skill in the art will recognize that various components and data stores of the logo detection computing system 110 may operate at different computing systems, such as a user computing system 120. For example, a user may elect to download and install one or more logo detection models from the logo detection store to persistently monitor for and detect logos that are being presented to the user while online. In this example, logo detection computing system 110, user computing systems 120, advertiser computing systems 130, and content provider computing systems 140 can communicate via network 150.

The computing devices and systems on which the logo detection system can be implemented can include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices can include keyboards, pointing devices, touchscreens, gesture recognition devices (e.g., for air gestures), thermostats, smart devices, head and eye tracking devices, microphones for voice or speech recognition, and so on. The computing devices can include desktop computers, laptops, tablets, e-readers, personal digital assistants, smartphones, gaming devices, servers, and computer systems such as massively parallel systems. The computing devices can each act as a server or client to other server or client devices. The computing devices can access computer-readable media that includes computer-readable storage media and computer-readable data transmission media. The computer-readable storage media are tangible storage means that do not include transitory, propagating signals. Examples of computer-readable storage media include memory such as data storage, primary memory, cache memory, and secondary memory (e.g., CD, DVD, Blu-Ray) and include other storage means. Moreover, data may be stored in any of a number of data structures and data stores, such as databases, files, lists, emails, distributed data stores, storage clouds, etc. The computer-readable storage media can have recorded upon or can be encoded with computer-executable instructions or logic that implements the logo detection system, such as a component comprising computer-executable instructions stored in one or more memories for execution by a computing system, by one or more processors, etc. In addition, the stored information can be encrypted. The data transmission media are used for transmitting data via transitory, propagating signals or carrier waves (e.g., electromagnetism) via a wired or wireless connection. In addition, the transmitted information can be encrypted. In some cases, the logo detection system can transmit various alerts to a user based on a transmission schedule, such as an alert to inform the user that one or more logos (or associated brands) have been detected in online advertisements. Furthermore, the logo detection system can transmit an alert over a wireless communication channel to a wireless device associated with a remote user or a computer of the remote user based upon a destination address associated with the user and a transmission schedule in order to, for example, periodically notify the user of detected logos (or brands). In some cases, such an alert can activate an application to cause the alert to display, on a remote user computer and to enable a connection via, a universal resource locator (URL), to a data source over the internet, for example, when the wireless device is locally connected to the remote user computer and the remote user computer comes online. Various communications links can be used, such as the Internet, a local area network, a wide area network, a point-to-point dial-up connection, a cell phone network, and so on for connecting the computing systems and devices to other computing systems and devices to send and/or receive data, such as via the Internet or another network and its networking hardware, such as switches, routers, repeaters, electrical cables and optical fibers, light emitters and receivers, radio transmitters and receivers, and the like. While computing systems and devices configured as described above are typically used to support the operation of the logo detection system, those skilled in the art will appreciate that the logo detection system can be implemented using devices of various types and configurations, and having various components.

The logo detection system can be described in the general context of computer-executable instructions, such as program modules, components, or operations, executed by one or more computers, processors, or other devices, including single-board computers and on-demand cloud computing platforms. Generally, program modules or components include routines, programs, objects, data structures, and so on that perform particular tasks or implement particular data types. Typically, the functionality of the program modules can be combined or distributed as desired in various embodiments. Aspects of the logo detection system can be implemented in hardware using, for example, an application-specific integrated circuit (“ASIC”).

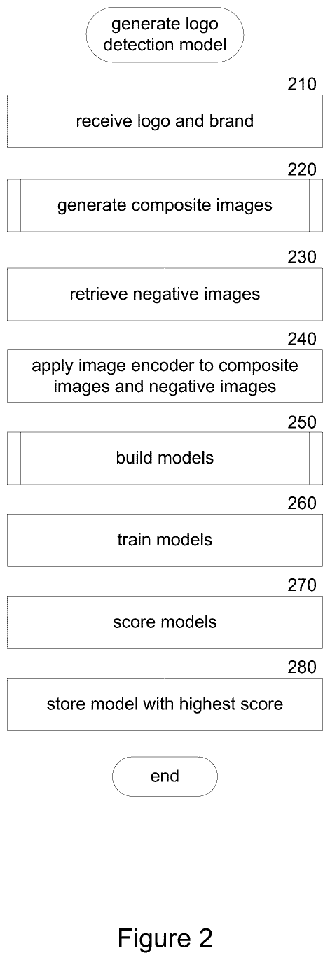

FIG. 2 is a flow diagram illustrating the processing of a generate logo detection component in accordance with some embodiments of the disclosed technology. The logo detection system invokes the generate logo detection model component to generate and store one or more models for detecting a particular logo image in images, such as logo for a shoe brand or a hotel in an online advertisement. In block 210, the generate logo detection model component receives an image that includes the logo, such as a logo found by a user online, along with an indication of a brand name or company name associated with the logo. In some examples, the generate logo detection model component may pre-process the logo image to isolate and/or normalize each logo within the logo image, such as removing background colors, cropping a logo image to a smaller size without occluding the logo, removing compression artifacts from a logo image, and so on. In some cases, the generate logo detection model component may invoke known third-party applications to pre-process the logo image. In block 220, the generate logo detection model component invokes a generate composite images component to generate, for example, synthetic advertisements that include the logo image. In block 230, the generate logo detection model component retrieves or constructs negative image examples corresponding to advertisements that do not include the image logo, such as advertisements stored in advertisement store 116 that are not associated with the brand received in block 210, composite images generated using logo images for other brands, and so on. In block 240, the generate logo detection model component applies an image encoder to each of the composite images generated at block 220 and each of the negative images retrieved or constructed in block 230 to extract a feature vector from each of the composite and negative images. In block 250, the generate logo detection model component invokes a build models component to randomly build candidate machine learning models for detecting the logo image. In block 260, the generate logo detection model component trains the generated models using the feature vectors extracted from the composite images and the negative images in block 240. In block 270, the component scores each of the models based on, for example, a weighted sum of various metrics for each model, such as positive class validation accuracy, negative class validation accuracy, an over-fit metric, and so on. In block 280 the model with the highest score is selected and stored in association with the brand and the logo image, such as in logo detection model store 115 with a reference to a corresponding entry in brand/logo store 117 and then completes. In some cases, the generate logo detection model component may select and store multiple logo detection models if, for example, the highest scoring models are within a predetermined threshold (e.g., 0.5%, 2%, 10%, etc.).

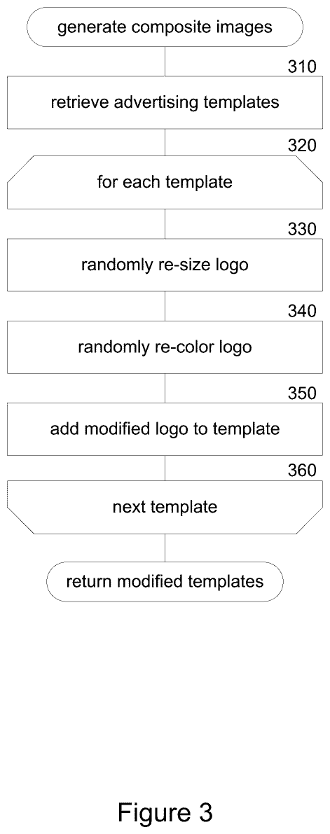

FIG. 3 is a flow diagram illustrating the processing of a generate composite images component in accordance with some embodiments of the disclosed technology. Generate logo detection model component 111 invokes generate composite images component to generate composite images that include the logo image for which the generate logo detection model was invoked (e.g., synthetic advertisements). In block 310, the generate composite images component retrieves advertisement templates, such as advertisements from advertisement store 116, advertisements scraped from online resources, advertisements provided by a user, and so on. In some examples, the number of advertisement templates retrieved is a fixed (e.g., 100, 250, 5000, etc.) or provided by a user. In block 320-360, the generate composite images component loops through each of the retrieved templates, randomly transforms the logo image, and adds the transformed logo image to the advertising template. In block 330, the generate composite images component transforms the logo image by, for example, randomly re-sizing and/or rotating the logo image. In block 340, the generate composite images component transforms the logo image by randomly re-coloring the logo image by, for example, changing the most common pixel values in the logo image to another color having high or limited contrast with the background of the template, etc. Although, re-sizing and coloring transformations are shown, one of ordinary skill in the art will recognize that any type of transforms may be applied, such as other affine transformations, other filter transformations, other color transformations, and so on. In some cases, the logo detection system may apply boundaries limits to the transformation to ensure that the logo image does not become too small or too large (e.g., smaller or larger than a predetermined width or height, smaller than a predetermined percentage of the width or height of the template), and so on. In block 350, the generate composite images component inserts the transformed logo image into the template at a random position. In some examples, the generate composite images component may re-size the template or select another random position at which to insert the transformed image if, for example, a randomly selected position would place the transformed logo (or a portion thereof) outside of the template. In some examples, the generate composite images component may insert multiple transformed logos into a single template or may insert multiple transformed logos into multiple copies of the same template. In block 360, if there are any retrieved templates remaining, then the generate composite images component loops back to block 320 to select the next template, else the generate composite images component returns the transformed templates (or references thereto) to the generate logo detection model component and then completes.

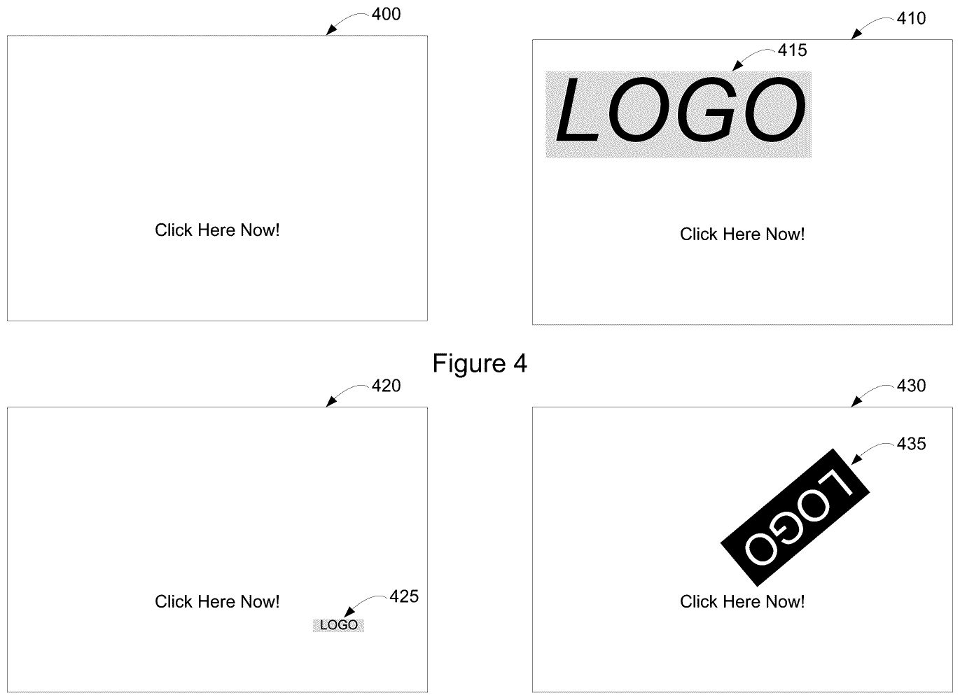

FIG. 4 is a block diagram illustrating example composite images (e.g., synthetic advertisements) in accordance with some embodiments of the disclosed technology. In these examples, a simple logo containing the word “LOGO” in black with a gray background is transformed and inserted into an advertisement template 400 that includes the phrase “Click Here Now!” In example 410, the logo 415 has been enlarged, skewed, and placed near the upper left hand corner of the template. In example 420, the logo 425 has been reduced in size and placed near the bottom right hand corner of the template. In example 430, the logo 435 has been re-colored (black to white and gray to black), rotated, and placed right of center of the template. One of ordinary skill in the art will recognize that these examples are illustrative and that any number of unique composite images may be generated using the techniques described herein.

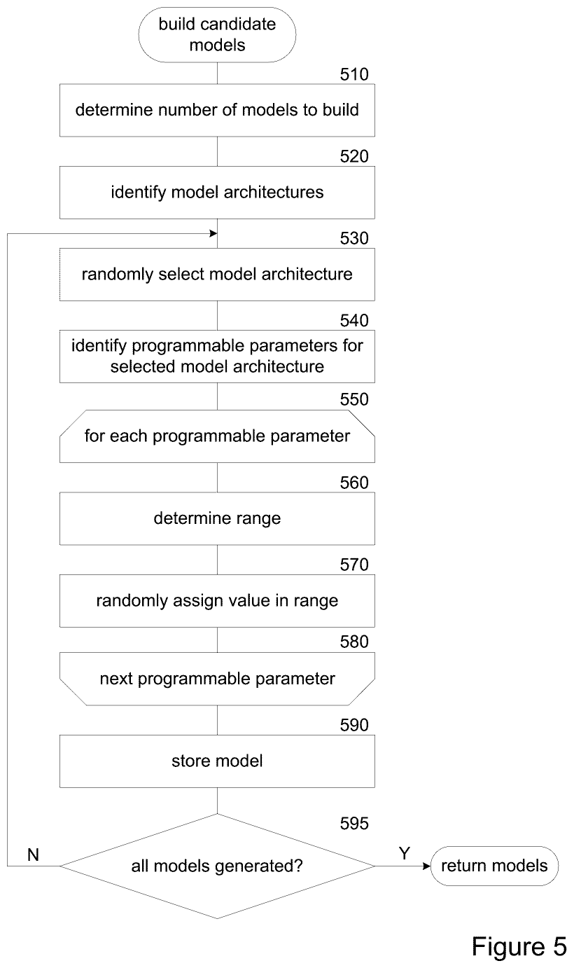

FIG. 5 is a flow diagram illustrating the processing of a build candidate models component in accordance with some embodiments of the disclosed technology. Build candidate models component is invoked by generate logo detection model component 111 to build random candidate models for detecting a logo image. In block 510, the build candidate models component determines a number of candidate models to build, which may be designated by a user or determined randomly based on a predetermined range. In block 520, the build candidate models component identifies a set of available model architectures by, for example, retrieving a previously stored list of available model architectures, a list of model architectures designated by a user, and so on. In block 530, the build candidate models component randomly selects a model architecture from the identified set of available model architectures. In block 540, the build candidate models component identifies programmable parameters and/or hyperparameters for the selected model architecture, such as a list of parameters and/or hyperparameters stored in association with the model architecture in, for example, a model store. In blocks 550-580, the build candidate models component loops through each of the parameters and/or hyperparameters to randomly assign a value to each. In block 560, the build candidate models component determines a range for the currently selected programmable parameter or hyperparameter based on, for example, range information stored about the model architecture in a model store. In block 570, the build candidate models component randomly selects a value in the determined range and assigns the value to the currently selected programmable parameter or hyperparameter. In block 580, if there are any programmable parameters or hyperparameters remaining, then the build candidate models component loops back to block 550 to select the next parameter or hyperparameter, else the build candidate models component continues at block 590. In block 590, the build candidate models component stores a model of the selected type with the determined parameter and/or hyperparameter values. In decision block 595, if the determined number of models have been built then the build candidate models component returns the models (or a reference thereto) to the generate logo detection model component and then completes, otherwise the build candidate models component loops back to block 530 to select a model architecture for another new model.

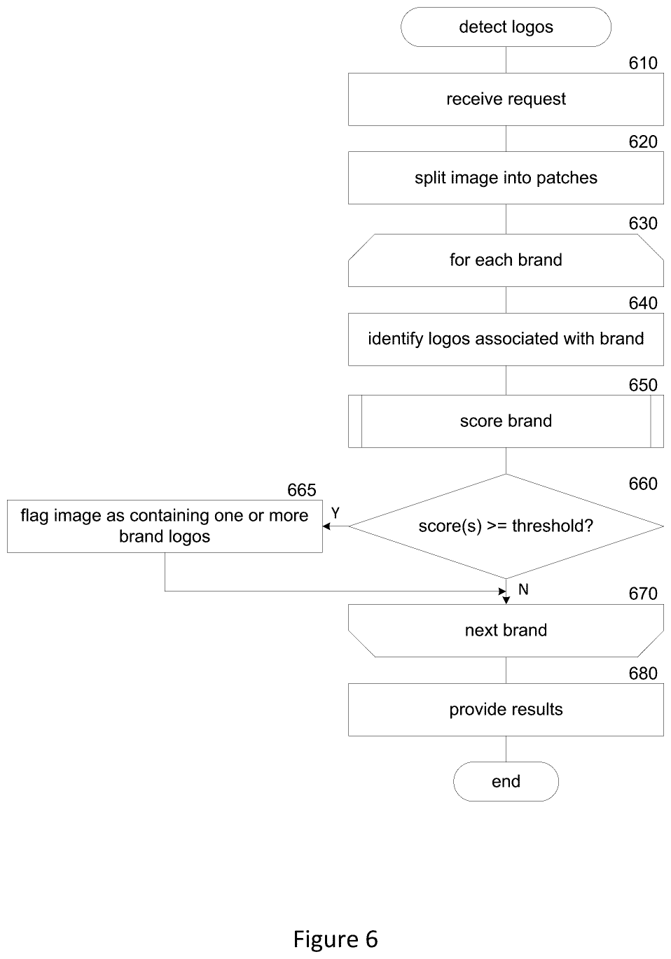

FIG. 6 is a flow diagram illustrating the processing of a detect logos component in accordance with some embodiments of the disclosed technology. The detect logos component is invoked by the logo detection system to determine whether there are any logos associated with one or more brands in a target image. In block 610, the detect logos component receives a request to determine whether a target image included (or identified/referenced) in the request includes any logos associated with one or more brands identified in the request. In block 620, the detect logos component splits the target image into one or more overlapping patches based on, for example, the size of the target image. One of ordinary skill in the art will recognize that the size of the overlapping patches may be fixed or user-configurable. For example, a user may specify a width and height for each patch and a number of pixels by which each patch should overlap adjoining patches. As another example, a user may set a number of horizontal and vertical patches and an overlap percentage and the detect logos component can determine the size of each patch based on width and height of the target image. Additional techniques for segmenting images is described in U.S. patent application Ser. No. 10,607,331, which is herein incorporated by reference in its entirety. In blocks 630-670, the detect logos component loops through each brand identified in the received request to identify logos associated with the brand and score the brand (and/or its associated logos) to determine the likelihood that a logo associated with the brand is in the target image. In block 640, the detect logos component identifies logos associated with the currently selected brand by, for example, accessing brand/logo store 117, which stores associations between brands and logos. In block 650, the detect logos component invokes a score brand component to generate a score for the currently selected brand (and/or its associated logos). In decision block 660, if the score or scores generated for the brand exceed a predetermined threshold, then the detect logos component continues at block 665, else the detect logos component continues at block 670. In block 665, the detect logos component flags the target image as containing one or more logos associated with the currently selected brand and then continues at block 670. In block 670, if there are any additional brands to be processed, then the detect logos component loops back to block 630 to select the next brand, else the component continues at block 680. In block 680, the detect logos component provides the results of the logo detection analysis and then completes. In some cases, the results may include an indication of each brand and each logo along with a probability that the target image includes the brand or logo. For example, the detect logos component may generate a report that includes, for each brand, a probability associated with whether the target image includes a logo associated with the brand. As another example, the report may include, for each logo associated with the brands identified in the request, a probability associated with whether the target image includes the logo. In some cases, if the request identified multiple brands, the report may identify the brand that is most likely to be associated with a logo included in the target image (e.g., the brand associated with the logo with the highest score).

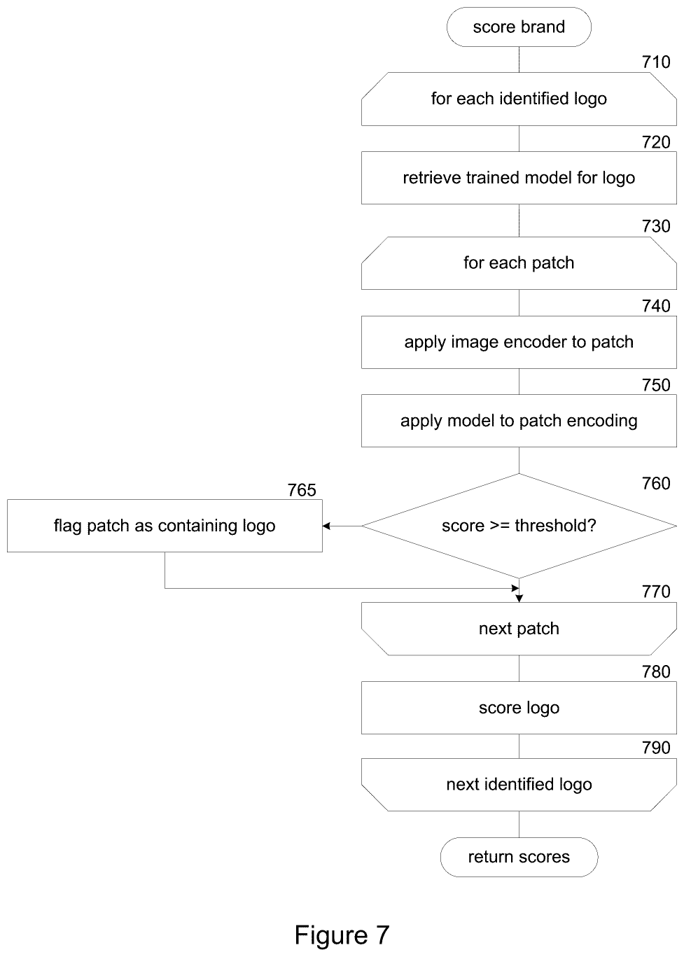

FIG. 7 is a flow diagram illustrating the processing of a score brand component in accordance with some embodiments of the disclosed technology. Score brand component is invoked by detect logos component to generate scores for logos associated with a brand, each score corresponding to a probability that a target image includes the corresponding logo. In blocks 710-790, the score brand component loops through each of the logos identified in block 640 (i.e., the logos associated with the currently selected brand) to generate a score for the logo corresponding to the probability that the target image includes the logo. In block 720, the score brand component retrieves one or more trained logo detection models associated with the logo. For example, the score brand component may access a brand/logo store to identify a reference or foreign key to a logo detection model stored in a model store. The retrieved trained logo detection model(s) correspond to logo detection model(s) generated and trained specifically for the currently selected logo, such as a logo detection model generated by generate logo detection model component described above with reference to FIG. 2. In blocks 730-770, the score brand component loops through each of the target image patches generated in block 620 to determine, using the retrieved model, a likelihood that the target image patch includes the currently selected logo. In block 740, the component applies the image encoder used to generate the training set for the retrieved model (i.e., the model generated to detect the currently selected logo) to the currently selected target image patch to generate a feature vector for the target image patch. In block 750, the score brand component applies the retrieved logo detection model to the feature vector generated for the currently selected target image patch to generate a score for the currently selected target image patch, the score corresponding to a probability that the target image patch includes the logo. In decision block 760, if the score is greater than or equal to a predetermined threshold, then the score brand component continues at block 765, else the component continues at block 770. In block 765, the component flags the currently selected target image patch as including the logo and then continues at block 770. In block 770, if there are any remaining patches to be processed then the component loops back to block 730 to select the next patch, else the score brand component continues at block 780. In block 780, the score brand component generates a score for the logo based on the scores generated for target image patches flagged by block 765, such as the average (e.g., arithmetic mean, geometric mean, median, mode) score for the flagged patches, the maximum score for the flagged patches, and so on. In block 790, if there are any remaining logos to be processed then the component loops back to block 710 to select the next logo, else the score brand component returns one or more scores to the detect logo component, such as individual scores for each logo and/or a score for the brand (i.e., the highest score generated for any logo associated with the brand) and then completes.

Unless the context clearly requires otherwise, throughout the description and the claims, the words “comprising,” “comprise,” and the like are to be construed in an inclusive sense, as opposed to an exclusive or exhaustive sense; that is to say, in the sense of “including, but not limited to.” As used herein, the terms “coupled,” “connected,” or any variant thereof, mean any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number, respectively. The word “or” in reference to a list of two or more items, covers all of the following interpretations of the word: any of the items in the list all of the items in the list, and any combination of the items in the list.

The above Detailed Description of examples of the disclosed subject matter is not intended to be exhaustive or to limit the disclosed subject matter to the precise form disclosed above. While specific examples for the disclosed subject matter are described above for illustrative purposes, various equivalent modifications are possible within the scope of the disclosed subject matter, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative combinations or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples: alternative implementations can employ differing values or ranges. Although generally described herein as pertaining to the identification of logos in advertisements, one of ordinary skill in the art will recognize that the disclosed technology can be used to detect different objects in images other than advertisements.

The disclosure provided herein can be applied to other systems, and is not limited to the system described herein. The features and acts of various examples included herein can be combined to provide further implementations of the disclosed subject matter. Some alternative implementations of the disclosed subject matter can include not only additional elements to those implementations noted above, but also can include fewer elements.

Any patents and applications and other references noted herein, including any that can be listed in accompanying filing papers, are incorporated herein by reference in their entireties. Aspects of the disclosed subject matter can be changed, if necessary, to employ the systems, functions, components, and concepts of the various references described herein to provide yet further implementations of the disclosed subject matter.

These and other changes can be made in light of the above Detailed Description. While the above disclosure includes certain examples of the disclosed subject matter, along with the best mode contemplated, the disclosed subject matter can be practiced in any number of ways. Details of the logo detection system can vary considerably in the specific implementation, while still being encompassed by this disclosure. Terminology used when describing certain features or aspects of the disclosed subject matter does not imply that the terminology is being redefined herein to be restricted to any specific characteristics, features, or aspects of the disclosed subject matter with which that terminology is associated. In general, the terms used in the following claims should not be construed to limit the disclosed subject matter to specific examples disclosed herein, unless the above Detailed Description section explicitly defines such terms. The scope of the disclosed subject matter encompasses not only the disclosed examples, but also all equivalent ways of practicing or implementing the disclosed subject matter under the claims.

To reduce the number of claims, certain aspects of the disclosed subject matter are presented below in certain claim forms, but the applicant contemplates the various aspects of the disclosed subject matter in any number of claim forms. For example, aspects of the disclosed subject matter can be embodied as a means-plus-function claim, or in other forms, such as being embodied in a computer-readable medium. (Any claims intended to be treated under 35 U.S.C. § 112 (f) will begin with the words “means for,” but use of the term “for” in any other context is not intended to invoke treatment under 35 U.S.C. § 112 (f).) Accordingly, the applicant reserves the right to pursue additional claims after filing this application to pursue such additional claim forms, in either this application or in a continuing application.

Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

From the foregoing, it will be appreciated that specific embodiments of the disclosed subject matter have been described herein for purposes of illustration, but that various modifications can be made without deviating from the scope of the disclosed subject matter. For example, while detecting logos in advertisements has been described as one application, one of ordinary skill in the art will recognize that image encoders and detection models can be trained or optimized for detecting other types of objects in different types of digital images. Additionally, while advantages associated with certain embodiments of the new technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein. Although the subject matter has been described in language specific to structural features and/or methodological acts, it is to be understood that the disclosed subject matter is not necessarily limited to the specific features or acts described above. Rather, the specific features and acts described above are disclosed as example forms of the disclosed subject matter. To the extent any materials incorporated herein by reference conflict with the present disclosure, the present disclosure controls.

Although many of the embodiments are described above with respect to systems, devices, and methods for logo detection, the technology is applicable to other applications and/or other approaches as well. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-7.

### EXAMPLES

The present technology is illustrated, for example, according to various examples described below. Various examples of aspects of the present technology are described as numbered examples for convenience. These are provided as examples and do not limit the disclosed technology. It is noted that any of the dependent examples may be combined in any combination, and placed into a respective independent example. The other examples can be presented in a similar manner.

Example 1: A method, performed by a computing system having a memory and a processor, for logo detection, the method comprising: receiving an image corresponding to a logo; receiving an indication of a brand associated with the logo; generating a plurality of synthetic advertisements; generating a set of positive feature vectors at least in part by, for each of the synthetic advertisements, applying an image encoder to the synthetic advertisement to generate a positive feature vector for the synthetic advertisement; generating a set of negative feature vectors at least in part by, for each of a plurality of advertisements that do not include the logo, applying the image encoder to the advertisement to generate a negative feature vector for the advertisement; generating a plurality of classification models at least in part by, selecting a classification model architecture, and for each of a plurality of parameters associated with the selected classification model architecture, identifying a range of acceptable values associated with the parameter, randomly determining a value within the identified range, and assigning the randomly determined value to the parameter; for each of the generated plurality of classification models, training the classification model based at least in part on the set of positive feature vectors and the set of negative feature vectors, and scoring the classification model; identifying, from among the trained classification models, the classification model with the highest score; and storing the identified classification model in association with the brand and the logo.

Example 2: The method of any of the Examples herein, further comprising: receiving a request to identify brands within a target image, the request including the target image and a list of target brands; splitting the target image up into one or more patches; for each of the one or more patches, applying the image encoder to the patch to generate a feature vector for the patch; for each brand on the list of target brands, retrieving one or more stored classification models associated with the brand, and for each of one or more of the retrieved classification models, generating a score for the brand at least in part by applying the retrieved classification model to the feature vectors generated for the one or more patches, and in response to determining that the score generated for the brand exceeds a predetermined threshold, adding the brand to a list of identified brands; and providing the list of identified brands to a user.

Example 3: The method of any of the Examples herein, wherein the image encoder is a neural network configured to receive an image as input and generate a fixed length, one dimensional feature vector for the image received as input.

Example 4: The method of any of the Examples herein, wherein providing the list of identified brands to a user comprises providing, for each of one or more logos associated with at least one identified brand, a probability that that the logo is included in the target image.

Example 5: The method of any of the Examples herein, wherein splitting the target image up into one or more patches comprises splitting the target image up into a predetermined number of overlapping patches.

Example 6: The method of any of the Examples herein, wherein generating the synthetic advertisements comprises: identifying a plurality of advertisement templates; and for each of the plurality of advertisement templates, randomly transforming a copy of the received image, and compositing the transformed copy of the received image onto the advertisement template to create a modified advertisement template.

Example 7: The method of any of the Examples herein, wherein the image encoder is a neural network and wherein generating the plurality of synthetic advertisements comprises creating a modified set of digital images by, for each digital image in a set of digital images, applying one or more transformations to the received image corresponding to the logo, the one or more transformations including mirroring, rotating, smoothing, or contrast reduction, and inserting the transformed image into the digital image, the method further comprising: creating a first training set comprising the set of digital images, the modified set of digital images, and a set of digital images that do not include the logo; training the neural network in a first pass using the first training set; creating a second training set for a second pass of training comprising the first training set and digital images that do not include the logo and that were incorrectly detected as including the logo after the first pass of training; and training the neural network in a second pass using the second training set.

Example 8: A computer-readable storage medium storing instructions that, when executed by a computing system having a memory and a processor, cause the computing system to perform a method for logo detection, the method comprising: receiving an image corresponding to a logo; receiving an indication of a brand associated with the logo; generating a set of positive feature vectors at least in part by, for each of a plurality of synthetic advertisements, applying an image encoder to the synthetic advertisement to generate a positive feature vector for the synthetic advertisement; generating a set of negative feature vectors at least in part by, for each of a plurality of advertisements that do not include the logo, applying the image encoder to the advertisement to generate a negative feature vector for the advertisement; generating a plurality of classification models at least in part by, selecting a classification model architecture, and for each of a plurality of parameters associated with the selected classification model architecture, identifying a range of acceptable values associated with the parameter, randomly determining a value within the identified range, and assigning the randomly determined value to the parameter; for each of the generated plurality of classification models, training the classification model based at least in part on the set of positive feature vectors and the set of negative feature vectors, and scoring the classification model; identifying, from among the trained classification models, the classification model with the highest score; and storing the identified classification model in association with the brand and the logo.

Example 9: The computer-readable storage medium of any of the Examples herein, the method further comprising: receiving a request to identify brands within a target image, the request including the target image and a list of target brands; splitting the target image up into one or more patches; for each of the one or more patches, applying the image encoder to the patch to generate a feature vector for the patch; for each brand on the list of target brands, retrieving one or more stored classification models associated with the brand, and for each of one or more of the retrieved classification models, generating a score for the brand at least in part by applying the retrieved classification model to the feature vectors generated for the one or more patches, and in response to determining that the score generated for the brand exceeds a predetermined threshold, adding the brand to a list of identified brands; and providing the list of identified brands to a user.

Example 10: The computer-readable storage medium of any of the Examples herein, wherein the image encoder is a neural network configured to receive an image as input and generate a fixed length, one dimensional feature vector for the image received as input.

Example 11 The computer-readable storage medium of any of the Examples herein, wherein providing the list of identified brands to a user comprises providing, for each of one or more logos associated with at least one identified brand, a probability that that the logo is included in the target image.

Example 12: The computer-readable storage medium of any of the Examples herein, wherein splitting the target image up into one or more patches comprises splitting the target image up into a predetermined number of overlapping patches.

Example 13: The computer-readable storage medium of any of the Examples herein, the method further comprising generating the synthetic advertisements at least in part by, identifying a plurality of advertisement templates; and for each of the plurality of advertisement templates, randomly transforming a copy of the received image, and compositing the transformed copy of the received image onto the advertisement template to create a modified advertisement template.

Example 14: The computer-readable storage medium of any of the Examples herein, the method further comprising: generating the plurality of synthetic advertisements at least in part by, creating a modified set of digital images by, for each digital image in a first set of digital images, applying one or more transformations to the received image corresponding to the logo, the one or more transformations including mirroring, rotating, smoothing, or contrast reduction, and inserting the transformed image into the digital image; creating a first training set comprising the first set of digital images, the modified set of digital images, and a set of digital images that do not include the logo; training the image encoder in a first pass using the first training set; creating a second training set for a second pass of training comprising the first training set and digital images that do not include the logo and that were incorrectly detected as including the logo after the first pass of training; and training the image encoder in a second pass using the second training set.

Example 15: A computing system, comprising at least one processor and at least one memory, for logo detection, the computing system comprising: a component configured to receive an image corresponding to a logo; a component configured to receive an indication of a brand associated with the logo; a component configured to generate a plurality of synthetic advertisements; a component configured to generate a set of positive feature vectors at least in part by, for each of the synthetic advertisements, applying an image encoder to the synthetic advertisement to generate a positive feature vector for the synthetic advertisement; a component configured to generate a set of negative feature vectors at least in part by, for each of a plurality of advertisements that do not include the logo, applying the image encoder to the advertisement to generate a negative feature vector for the advertisement; a component configured to apply the image encoder to each of a plurality of advertisements that do not include the logo to generate a set of negative feature vectors; a component configured to select a classification model architecture; a component configured to generate a plurality of classification models at least in part by, for each of a plurality of parameters associated with the selected classification model architecture, identifying a range of acceptable values associated with the parameter, randomly determining a value within the identified range, and assigning the randomly determined value to the parameter; a component configured to, for each of the generated plurality of classification models, train the classification model based at least in part on the set of positive feature vectors and the set of negative feature vectors, and score the classification model; a component configured to identify, from among the trained classification models, the classification model with the highest score; and a component configured to store the identified classification model in association with the brand and the logo, wherein each of the components comprises computer-executable instructions stored in the at least one memory for execution by the computing system.

Example 16: The computing system of any of the Examples herein, further comprising: a component configured to receive a request to identify brands within a target image, the request including the target image and a list of target brands; a component configured to split the target image up into one or more patches; a component configured to, for each of the one or more patches, apply the image encoder to the patch to generate a feature vector for the patch; a component configured to, for each brand on the list of target brands, retrieve one or more stored classification models associated with the brand, and for each of one or more of the retrieved classification models, generate a score for the brand at least in part by applying the retrieved classification model to the feature vectors generated for the one or more patches, and in response to determining that the score generated for the brand exceeds a predetermined threshold, add the brand to a list of identified brands; and a component configured to provide the list of identified brands to a user.

Example 17: The computing system of any of the Examples herein, wherein the image encoder is a neural network configured to receive an image as input and generate a fixed length, one dimensional feature vector for the image received as input.

Example 18: The computing system of any of the Examples herein, wherein the component configured to provide the list of identified brands to a user is configured to provide, for each of one or more logos associated with at least one identified brand, a probability that that the logo is included in the target image.

Example 19: The computing system of any of the Examples herein, wherein the component configured to split the target image up into one or more patches is configured to split the target image up into a predetermined number of overlapping patches.

Example 20: The computing system of any of the Examples herein, wherein the component configured to generate the synthetic advertisements is configured to: identify a plurality of advertisement templates; and for each of the plurality of advertisement templates, randomly transform a copy of the received image, and composite the transformed copy of the received image onto the advertisement template to create a modified advertisement template.

Example 21: A computer-implemented method of training a neural network for logo detection, the computer-implemented method comprising: collecting a digital logo image; collecting a set of digital images from a database; creating a modified set of digital images by, for each digital image in the set of digital images, applying one or more transformations to the digital logo image including mirroring, rotating, smoothing, or contrast reduction, and inserting the transformed digital logo image into the digital image; creating a first training set comprising the collected set of digital images, the modified set of digital images, and a set of digital images that do not include the digital logo image; training the neural network in a first pass using the first training set; creating a second training set for a second pass of training comprising the first training set and digital images that do not include the digital logo image that were incorrectly detected as including the digital logo image after the first pass of training; and training the neural network in a second pass using the second training set.

Example 22: A computer-readable storage medium storing instruction that, when executed by a computing system, cause the computing system to perform a method of training a neural network for logo detection, the method comprising: collecting a digital logo image; collecting a set of digital images from a database; creating a modified set of digital images by, for each digital image in the set of digital images, applying one or more transformations to the digital logo image including mirroring, rotating, smoothing, or contrast reduction, and inserting the transformed digital logo image into the digital image; creating a first training set comprising the collected set of digital images, the modified set of digital images, and a set of digital images that do not include the digital logo image; training the neural network in a first pass using the first training set; creating a second training set for a second pass of training comprising the first training set and digital images that do not include the digital logo image that were incorrectly detected as including the digital logo image after the first pass of training; and training the neural network in a second pass using the second training set.

Example 23: A computing system comprising: at least one memory; at least one processor; data storage having instructions stored thereon that, when executed by the at least one processor, cause the computing system to perform operations for logo detection, the operations comprising: collecting a digital logo image; collecting a set of digital images from a database; creating a modified set of digital images by, for each digital image in the set of digital images, applying one or more transformations to the digital logo image including mirroring, rotating, smoothing, or contrast reduction, and inserting the transformed digital logo image into the digital image; creating a first training set comprising the collected set of digital images, the modified set of digital images, and a set of digital images that do not include the digital logo image; training the neural network in a first pass using the first training set; creating a second training set for a second pass of training comprising the first training set and digital images that do not include the digital logo image that were incorrectly detected as including the digital logo image after the first pass of training; and training the neural network in a second pass using the second training set.

1. A method, performed by a computing system having a memory and a processor, for logo detection, the method comprising:
receiving an image corresponding to a logo;
receiving an indication of a brand associated with the logo;
generating a plurality of synthetic advertisements;
generating a set of positive feature vectors at least in part by, for each of the synthetic advertisements,
applying an image encoder to the synthetic advertisement to generate a positive feature vector for the synthetic advertisement;
generating a set of negative feature vectors at least in part by, for each of a plurality of advertisements that do not include the logo,
applying the image encoder to the advertisement to generate a negative feature vector for the advertisement;
generating a plurality of classification models at least in part by, selecting a classification model architecture, and
for each of a plurality of parameters associated with the selected classification model architecture,
identifying a range of acceptable values associated with the parameter,
randomly determining a value within the identified range, and
assigning the randomly determined value to the parameter;
for each of the generated plurality of classification models,
training the classification model based at least in part on the set of positive feature vectors and the set of negative feature vectors, and
scoring the classification model;
identifying, from among the trained classification models, the classification model with the highest score; and
storing the identified classification model in association with the brand and the logo.

2. The method of claim 1, further comprising:
receiving a request to identify brands within a target image, the request including the target image and a list of target brands;
splitting the target image up into one or more patches;
for each of the one or more patches,
applying the image encoder to the patch to generate a feature vector for the patch;
for each brand on the list of target brands,
retrieving one or more stored classification models associated with the brand, and
for each of one or more of the retrieved classification models,
generating a score for the brand at least in part by applying the retrieved classification model to the feature vectors generated for the one or more patches, and
in response to determining that the score generated for the brand exceeds a predetermined threshold, adding the brand to a list of identified brands; and
providing the list of identified brands to a user.

3. The method of claim 2, wherein the image encoder is a neural network configured to receive an image as input and generate a fixed length, one dimensional feature vector for the image received as input.

4. The method of claim 2, wherein providing the list of identified brands to a user comprises providing, for each of one or more logos associated with at least one identified brand, a probability that that the logo is included in the target image.

5. The method of claim 2, wherein splitting the target image up into one or more patches comprises splitting the target image up into a predetermined number of overlapping patches.

6. The method of claim 1, wherein generating the synthetic advertisements comprises:
identifying a plurality of advertisement templates; and
for each of the plurality of advertisement templates,
randomly transforming a copy of the received image, and
compositing the transformed copy of the received image onto the advertisement template to create a modified advertisement template.

7. The method of claim 1, wherein the image encoder is a neural network and wherein generating the plurality of synthetic advertisements comprises creating a modified set of digital images by, for each digital image in a set of digital images, applying one or more transformations to the received image corresponding to the logo, the one or more transformations including mirroring, rotating, smoothing, or contrast reduction, and inserting the transformed image into the digital image, the method further comprising:
creating a first training set comprising the set of digital images, the modified set of digital images, and a set of digital images that do not include the logo;
training the neural network in a first pass using the first training set;
creating a second training set for a second pass of training comprising the first training set and digital images that do not include the logo and that were incorrectly detected as including the logo after the first pass of training; and
training the neural network in a second pass using the second training set.

8. A computer-readable storage medium storing instructions that, when executed by a computing system having a memory and a processor, cause the computing system to perform a method for logo detection, the method comprising:
receiving an image corresponding to a logo;
receiving an indication of a brand associated with the logo;
generating a set of positive feature vectors at least in part by, for each of a plurality of synthetic advertisements,
applying an image encoder to the synthetic advertisement to generate a positive feature vector for the synthetic advertisement;
generating a set of negative feature vectors at least in part by, for each of a plurality of advertisements that do not include the logo,
applying the image encoder to the advertisement to generate a negative feature vector for the advertisement;
generating a plurality of classification models at least in part by, selecting a classification model architecture, and
for each of a plurality of parameters associated with the selected classification model architecture,
identifying a range of acceptable values associated with the parameter,
randomly determining a value within the identified range, and
assigning the randomly determined value to the parameter;
for each of the generated plurality of classification models,
training the classification model based at least in part on the set of positive feature vectors and the set of negative feature vectors, and
scoring the classification model;
identifying, from among the trained classification models, the classification model with the highest score; and
storing the identified classification model in association with the brand and the logo.

9. The computer-readable storage medium of claim 8, the method further comprising:
receiving a request to identify brands within a target image, the request including the target image and a list of target brands;
splitting the target image up into one or more patches;
for each of the one or more patches,
applying the image encoder to the patch to generate a feature vector for the patch;
for each brand on the list of target brands,
retrieving one or more stored classification models associated with the brand, and
for each of one or more of the retrieved classification models,
generating a score for the brand at least in part by applying the retrieved classification model to the feature vectors generated for the one or more patches, and
in response to determining that the score generated for the brand exceeds a predetermined threshold, adding the brand to a list of identified brands; and
providing the list of identified brands to a user.

10. The computer-readable storage medium of claim 9, wherein the image encoder is a neural network configured to receive an image as input and generate a fixed length, one dimensional feature vector for the image received as input.

11. The computer-readable storage medium of claim 9, wherein providing the list of identified brands to a user comprises providing, for each of one or more logos associated with at least one identified brand, a probability that that the logo is included in the target image.

12. The computer-readable storage medium of claim 9, wherein splitting the target image up into one or more patches comprises splitting the target image up into a predetermined number of overlapping patches.

13. The computer-readable storage medium of claim 8, the method further comprising generating the synthetic advertisements at least in part by,
identifying a plurality of advertisement templates; and
for each of the plurality of advertisement templates,
randomly transforming a copy of the received image, and
compositing the transformed copy of the received image onto the advertisement template to create a modified advertisement template.

14. The computer-readable storage medium of claim 8, the method further comprising:
generating the plurality of synthetic advertisements at least in part by,
creating a modified set of digital images by, for each digital image in a first set of digital images, applying one or more transformations to the received image corresponding to the logo, the one or more transformations including mirroring, rotating, smoothing, or contrast reduction, and
inserting the transformed image into the digital image;
creating a first training set comprising the first set of digital images, the modified set of digital images, and a set of digital images that do not include the logo;
training the image encoder in a first pass using the first training set;
creating a second training set for a second pass of training comprising the first training set and digital images that do not include the logo and that were incorrectly detected as including the logo after the first pass of training; and
training the image encoder in a second pass using the second training set.

15. A computing system, comprising at least one processor and at least one memory, for logo detection, the computing system comprising:
a component configured to receive an image corresponding to a logo;
a component configured to receive an indication of a brand associated with the logo;
a component configured to generate a plurality of synthetic advertisements;
a component configured to generate a set of positive feature vectors at least in part by, for each of the synthetic advertisements, applying an image encoder to the synthetic advertisement to generate a positive feature vector for the synthetic advertisement;
a component configured to generate a set of negative feature vectors at least in part by, for each of a plurality of advertisements that do not include the logo, applying the image encoder to the advertisement to generate a negative feature vector for the advertisement;
a component configured to apply the image encoder to each of a plurality of advertisements that do not include the logo to generate a set of negative feature vectors;
a component configured to select a classification model architecture;
a component configured to generate a plurality of classification models at least in part by,
for each of a plurality of parameters associated with the selected classification model architecture,
identifying a range of acceptable values associated with the parameter,
randomly determining a value within the identified range, and
assigning the randomly determined value to the parameter;
a component configured to, for each of the generated plurality of classification models,
train the classification model based at least in part on the set of positive feature vectors and the set of negative feature vectors, and
score the classification model;
a component configured to identify, from among the trained classification models, the classification model with the highest score; and
a component configured to store the identified classification model in association with the brand and the logo,
wherein each of the components comprises computer-executable instructions stored in the at least one memory for execution by the computing system.

16. The computing system of claim 15, further comprising:
a component configured to receive a request to identify brands within a target image, the request including the target image and a list of target brands;
a component configured to split the target image up into one or more patches;
a component configured to, for each of the one or more patches,
apply the image encoder to the patch to generate a feature vector for the patch;
a component configured to, for each brand on the list of target brands, retrieve one or more stored classification models associated with the brand, and
for each of one or more of the retrieved classification models,
generate a score for the brand at least in part by applying the retrieved classification model to the feature vectors generated for the one or more patches, and
in response to determining that the score generated for the brand exceeds a predetermined threshold, add the brand to a list of identified brands; and
a component configured to provide the list of identified brands to a user.

17. The computing system of claim 16, wherein the image encoder is a neural network configured to receive an image as input and generate a fixed length, one dimensional feature vector for the image received as input.

18. The computing system of claim 16, wherein the component configured to provide the list of identified brands to a user is configured to provide, for each of one or more logos associated with at least one identified brand, a probability that that the logo is included in the target image.

19. The computing system of claim 16, wherein the component configured to split the target image up into one or more patches is configured to split the target image up into a predetermined number of overlapping patches.

20. The computing system of claim 15, wherein the component configured to generate the synthetic advertisements is configured to:
identify a plurality of advertisement templates; and
for each of the plurality of advertisement templates,
randomly transform a copy of the received image, and
composite the transformed copy of the received image onto the advertisement template to create a modified advertisement template.
